(19) United States
(12) Patent Application Publication
(10) Pub. No.: US 2015/0338701 A1
(43) Pub. Date: Nov. 26, 2015

(54) COLOR FILTER SUBSTRATE AND MANUFACTURING METHOD THEREOF AND DISPLAY DEVICE

(71) Applicant: BOE TECHNOLOGY GROUP CO., LTD., Beijing (CN)

(72) Inventors: Ki Man KIM, Beijing (CN); Guangkui QIN, Beijing (CN); Jaegeon YOU, Beijing (CN)

(21) Appl. No.: 14/421,486

(22) PCT Filed: Jul. 10, 2014
(86) PCT No.: PCT/CN2014/081982

§ 371 Date: Feb. 13, 2015

(30) Foreign Application Priority Data
Dec. 31, 2013 (CN) 201310752557.6

(51) Int. Cl. G02F 1/1335; G02B 5/20; G02B 5/22

(52) U.S. Cl. CPC G02F 1/133516; G02B 5/22; G02B 5/201; G02F 2001/133519

(57) ABSTRACT

A color filter substrate comprises: a substrate and a color filter formed on the substrate; and a color conversion layer, a first refractive index film layer, a second refractive index film layer and a third refractive index film layer formed in turn on a side of the color filter facing away from the substrate. The second refractive index film layer has a refractive index larger than that of the third refractive index film layer, larger than that of the first refractive index film layer under a condition of powering down, and smaller than that of the first refractive index film layer under a condition of powering up. The color filter is configured to absorb a portion of outside light, which creates photoluminescence reaction with the color conversion layer, thereby to avoid white color caused by the photoluminescence reaction, and to allow the display color brighter.

### TECHNICAL FIELD

Embodiments of the present invention relate to a color filter substrate and manufacturing method thereof and a display device.

### BACKGROUND

Currently, a liquid crystal display (LCD) and an organic light emitting diode (OLED) have dominated in the market of the flat panel display (FPD). However, the LCD is experiencing some challenges, such as a complexity structure, the compositing problem of two glass substrates sandwiching a liquid crystal cell and the problem of an illuminating system referred to a backlight unit. Furthermore, the LCD experiences an inefficient due to the low light transmittance of the LCD panel. Although OLED has ideal characteristics theoretically, in practical application, OLED experiences challenges that it is difficult for the panel to be made larger and the structure of backplane is complicated. The commercial market requires a display that has a simple structure, high efficiency and attractive properties. An integrated optical display thus becomes a hot topic in research. However, in an outside bright light, display pictures of the display are whitened and are not bright because the outside light is reflected on the surface of the display.

### SUMMARY

At least one embodiments of the present invention provide a color filter substrate, which comprises a substrate and a color filter formed on the substrate; and a color conversion layer, a first refractive index film layer, a second refractive index film layer and a third refractive index film layer provided in turn on a side of the color filter facing away from the substrate, wherein the color filter is configured to absorb a portion of outside light, which creates photoluminescence reaction with the color conversion layer.

In an example, the second refractive index film layer has a refractive index larger than that of the third refractive index film layer, larger than that of the first refractive index film layer under a condition of powering down, and smaller than that of the first refractive index film layer under a condition of powering up.

In an example, the color conversion layer comprises an array formed of a plurality of color conversion units of N colors; the color filter comprises an array formed of a plurality of color filtering units of N colors, wherein each color filtering unit corresponds to one color conversion unit, and the color filtering unit has a same color as the converted color by the corresponding color conversion unit, where N≧2.

In an example, the first refractive index film layer is a liquid crystal layer.

In an example, the color conversion layer is formed of fluorescent material.

At least one embodiments of the present invention provide a method of manufacturing a color filter substrate, which comprises: forming a color filter on a substrate; and forming a color conversion layer, a first refractive index film layer, a second refractive index film layer and a third refractive index film layer in turn on a side of the color filter facing away from the substrate, wherein the color filter is configured to absorb a portion of outside light, which creates photoluminescence reaction with the color conversion layer.

In an example, the second refractive index film layer has a refractive index larger than that of the third refractive index film layer, larger than that of the first refractive index film layer under a condition of powering down, and smaller than that of the first refractive index film layer under a condition of powering up.

In an example, during forming the color conversion layer, the color conversion unit is formed on the corresponding region of the color filter, the formed color conversion unit has a same color as that of the corresponding region of the color filter, and the color conversion units with different colors form the color conversion layer together.

In an example, the first refractive index film layer is a liquid crystal layer.

In an example, the color conversion layer is formed of fluorescent material.

At least one embodiments of the present invention provide a display device, which comprises any of above color filter substrates.

### BRIEF DESCRIPTION OF THE DRAWINGS

Embodiments of the present invention will be described in detail hereinafter in conjunction with accompanying drawings to allow one of ordinary skilled in the art to understand the present invention more clearly, in which:

FIG. 1 is a schematic view of a color filter substrate according to an embodiment of the present invention;

FIG. 2 is a schematic diagram of avoiding white pictures by using the display device comprising the color filter substrate of FIG. 1.

### DETAILED DESCRIPTION OF THE PREFERRED EMBODIMENTS

In order to make objects, technical solutions and advantages of the embodiments of the invention apparent, technical solutions according to the embodiments of the present invention will be described clearly and completely as below in conjunction with the accompanying drawings of embodiments of the present invention. It is apparent that the described embodiments are only a part of but not all of exemplary embodiments of the present invention. Based on the described embodiments of the present invention, various other embodiments can be obtained by those of ordinary skill in the art without creative labor and those embodiments shall fall into the protection scope of the present invention.

Unless otherwise defined, all the technical and scientific terms used herein have the same meanings as commonly understood by one of ordinary skill in the art to which the present invention belongs. The terms, such as “first,” “second,” or the like, which are used in the description and the claims of the present application, are not intended to indicate any sequence, amount or importance, but for distinguishing various components. Also, the terms, such as “a/an,” “one,” or the like, are not intended to limit the amount, but for indicating the existence of at lease one. The terms, such as “comprise/comprising,” “include/including,” or the like are intended to specify that the elements or the objects stated before these terms encompass the elements or the objects and equivalents thereof listed after these terms, but not preclude other elements or objects. The terms, “on,” “under,” or the like are only used to indicate relative position relationship, and when the position of the object which is described is changed, the relative position relationship may be changed accordingly.

Embodiments of the present invention provides a display based on integrated optical elements and a color filter substrate used in the display which can meet potential requirements of novel display and has a simple structure, a high efficiency, an excellent transmittance and a brighter color.

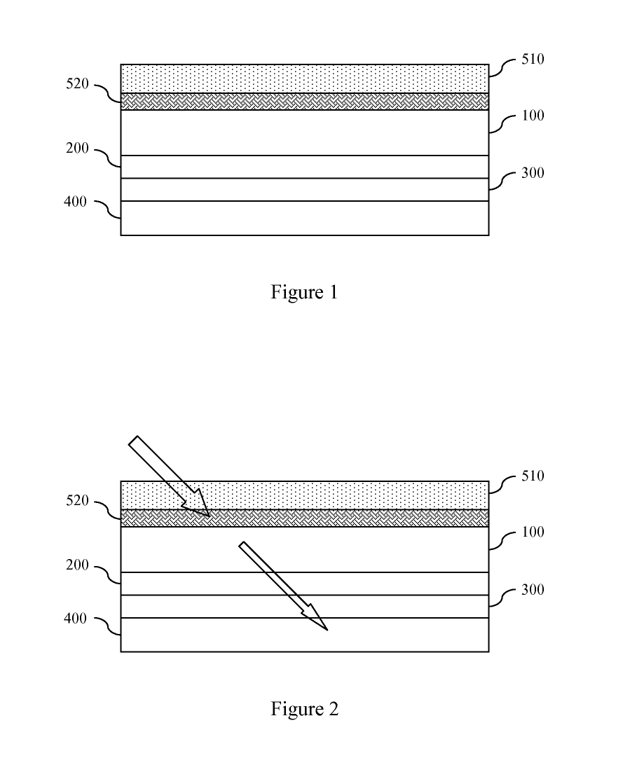

As shown in FIGS. 1 and 2, the color filter substrate provided by embodiments of the present invention comprises a substrate 510 and a color filter 520 formed on the substrate 510; and a color conversion layer 100, a first refractive index film layer 200, a second refractive index film layer 300 and a third refractive index film layer 400 formed on a side of the color filter 520 facing away from the substrate. The second refractive index film layer 300 has a refractive index larger than that of the third refractive index film layer 400, larger than that of the first refractive index film layer 200 under a condition of powering down, and smaller than that of the first refractive index film layer 200 under a condition of powering up. The color filter 520 is configured to absorb a portion of outside light, which creates photoluminescence reaction with the color conversion layer 100. The first refractive index film layer 200 can be a liquid crystal layer.

The color conversion layer 100 is an array formed of fluorescent material used to convert different colors of light (e.g. red, green), and corresponds to the same color of the color filter.

When the first refractive index film layer 200 is not powered up, the color conversion layer 100 moves light towards the second refractive index film layer 300 having high refractive index between the first refractive index film layer 200 and the third refractive index film layer 400 having low refractive index in a manner of total reflection. When the first refractive index film layer 200 is powered up, the refractive index of the first refractive index film layer 200 is increased so that the total reflection condition is broken, and the light is extracted and is incident on the color conversion layer 100, thereby to obtain the required wavelength of light.

However, when ordinary outside white light is incident on the display device, the outside light is incident towards to the color conversion layer 100, a portion of outside light creates photoluminescence reaction with the color conversion material (CCM); that is, the light having specific wavelength of the outside light is absorbed and released by the fluorescent material of the color conversion layer 100 so that images released from the display device become blurred. As shown in FIG. 2, the color filter 520 is configured to absorb a portion of outside light, which creates photoluminescence reaction with the color conversion layer 100; that is, when the outside light is incident on the color filter 520, only specific wavelength of the light is allowed to transmit through the color filter 520; that is, only the portion of the light that does not create photoreaction is allowed to transmit through the color filter 520, and the other wavelength of the light is absorbed by the color filter, thereby to avoid white pictures caused by the photoluminescence reaction when the outside white light radiate on the color conversion layer 100, and thereby to make the display color brighter.

At least one embodiments of the present invention further provide a method of manufacturing the color substrates, which comprises: forming a color filter on a substrate; and forming a color conversion layer, a first refractive index film layer, a second refractive index film layer and a third refractive index film layer in turn on a side of the color filter facing away from the substrate. The second refractive index film layer has a refractive index larger than that of the third refractive index film layer, larger than that of the first refractive index film layer under a condition of powering down, and smaller than that of the first refractive index film layer under a condition of powering up. The color filter is configured to absorb a portion of the outside light, which creates photoreaction with the color conversion layer.

The first refractive index film layer is a liquid crystal layer. The color conversion layer is formed of fluorescent material.

In the present embodiment, the method of manufacturing the color conversion layer comprises: forming the color conversion unit on the corresponding region of the color filter, wherein the color conversion unit has the same color as that of the corresponding region of the color filter; the color conversion units with different colors form the color conversion layer together.

The embodiment of the present invention further provides a display device comprising the color filter substrate, and the display device has a better color brightness.

In the present embodiments of the present invention, the color conversion layer, the first refractive index film layer, the second refractive index film layer and the third refractive index film layer are formed on the color filter substrate; when the outside white light is incident on the color filter, only specific wavelength of the light is allowed to transmit through the color filter; that is, only the component of the light that does not create photoreaction is allowed to transmit through the color filter, and other wavelength of the light is absorbed by the color filter so that the display device would not occur white color when the outside white light radiates on the color conversion layer, and thereby to allow the display color brighter.

It should be understood that the described above are only illustrative implementations for explaining the present invention, and the present invention is not intended to limited thereto. For one of ordinary skilled in the art, various modifications and improvements may be made without departing from the spirit and scope of the present invention, and all of which and equivalent technical solutions should fall within the protection scope of the present invention, which is defined by the claims.

The present application claims priority of Chinese patent application No. 201310752557.6 filed on Dec. 31, 2013 titled “Color filter Substrate and Manufacturing Method Thereof, Display Device”, the contents of which are incorporated herein by reference.

1. A color filter substrate, comprising:
a substrate;
a color filter formed on the substrate; and
a color conversion layer, a first refractive index film layer, a second refractive index film layer and a third refractive index film layer provided in turn on a side of the color filter facing away from the substrate;
wherein the color filter is configured to absorb a portion of outside light, which creates photoluminescence reaction with the color conversion layer.

2. The color filter substrate according to claim 1, wherein the second refractive index film layer has a refractive index larger than that of the third refractive index film layer, larger than that of the first refractive index film layer under a condition of powering down, and smaller than that of the first refractive index film layer under a condition of powering up.

3. The color filter substrate according to claim 1, wherein the color conversion layer comprises an array formed of a plurality of color conversion units of N colors; the color filter comprises an array formed of a plurality of color filtering units of N colors, wherein each color filtering unit corresponds to one color conversion unit, and the color filtering unit has a same color as the converted color by the corresponding color conversion unit, where N≧2.

4. The color filter substrate according to claim 1, wherein the first refractive index film layer is a liquid crystal layer.

5. The color filter substrate according to claim 1, wherein the color conversion layer is formed of fluorescent material.

6. A method of manufacturing a color filter substrate, comprising:
forming a color filter on a substrate; and
forming a color conversion layer, a first refractive index film layer, a second refractive index film layer and a third refractive index film layer in turn on a side of the color filter facing away from the substrate;
wherein the color filter is configured to absorb a portion of outside light, which creates photoluminescence reaction with the color conversion layer.

7. The method of manufacturing the color filter substrate according to claim 6, wherein the second refractive index film layer has a refractive index larger than that of the third refractive index film layer, larger than that of the first refractive index film layer under a condition of powering down, and smaller than that of the first refractive index film layer under a condition of powering up.

8. The method of manufacturing the color filter substrate according to claim 6, wherein, during forming the color conversion layer, the color conversion unit is formed on the corresponding region of the color filter, the formed color conversion unit has a same color as that of the corresponding region of the color filter, and the color conversion units with different colors form the color conversion layer together.

9. The method of manufacturing the color filter substrate according to claim 6, wherein the first refractive index film layer is a liquid crystal layer.

10. The method of manufacturing the color filter substrate according to claim 6, wherein the color conversion layer is formed with fluorescent material.

11. A display device, comprising the color filter substrate according to claim 1.

12. The color filter substrate according to claim 2, wherein the color conversion layer comprises an array formed of a plurality of color conversion units of N colors;
the color filter comprises an array formed of a plurality of color filtering units of N colors, wherein each color filtering unit corresponds to one color conversion unit, and the color filtering unit has a same color as the converted color by the corresponding color conversion unit, where N ≧2.

13. The color filter substrate according to claim 12, wherein the first refractive index film layer is a liquid crystal layer.

14. The color filter substrate according to claim 3, wherein the first refractive index film layer is a liquid crystal layer.

15. The color filter substrate according to claim 2, wherein the color conversion layer is formed of fluorescent material.

16. The color filter substrate according to claim 3, wherein the color conversion layer is formed of fluorescent material.

17. The color filter substrate according to claim 4, wherein the color conversion layer is formed of fluorescent material.

18. The method of manufacturing the color filter substrate according to claim 7, wherein, during forming the color conversion layer, the color conversion unit is formed on the corresponding region of the color filter, the formed color conversion unit has a same color as that of the corresponding region of the color filter, and the color conversion units with different colors form the color conversion layer together.

19. The method of manufacturing the color filter substrate according to claim 18, wherein the first refractive index film layer is a liquid crystal layer.

20. The method of manufacturing the color filter substrate according to claim 8, wherein the color conversion layer is formed with fluorescent material.
